(19) United States
(12) Patent Application Publication
(10) Pub. No.: US 2004/0161356 A1
(43) Pub. Date: Aug. 19, 2004

(54) Volumetric pump

(75) Inventor: Frederic Cottais, Clermont-Ferrand (FR)

Correspondence Address: BURNS DOANE SWECKER & MATHIS L L P, POST OFFICE BOX 1404, ALEXANDRIA, VA, 22313-1404, US

(73) Assignee: Michelin Recherche et Technique S.A., Granges-Paccot (CH)

(21) Appl. No.: 10/778,208

(22) Filed: Feb. 17, 2004

Related U.S. Application Data
(63) Continuation of application No. PCT/EP02/08969, filed on Aug. 9, 2002.

(30) Foreign Application Priority Data
Aug. 16, 2001 (FR) 01/10880

(51) Int. Cl. F03C 2/00; F04C 18/00

(52) U.S. Cl. 418/201.1

(57) ABSTRACT

The invention relates to a volumetric pump, in particular for rubber mixes, comprising feeding means for delivering the material to an enclosure which opens into an outlet orifice and in which rotate two contra-rotating screws which mesh with one another by means of the respective helicoidal threads which they bear, the axial length of the meshing zone of these screws being greater than or equal to the total of the helix pitch of the threads and of the helix pitch multiplied by the number of threads of each screw multiplied by two.

This application is a continuation of International Application Serial No. PCT/EP02/08969 filed on Aug. 9, 2002, which claims priority from French Application Serial No. 01/10880 filed on Aug. 16, 2001, the entire content of which is hereby incorporated by reference.

### BACKGROUND OF THE INVENTION

The present invention relates to volumetric pumps intended in particular for rubber mixes and, more particularly, to gear pumps.

It is known to use volumetric gear pumps for high-viscosity plastics materials such as the one described in Greenstreet et al. U.S. Pat. No. 5,120,206. A pump of this type uses a gear system comprising a motorized driving gear wheel, “driving wheel”, and a second wheel engaged with the first and driven in rotation thereby, and also a feed screw which makes it possible to force-feed said pump with high-viscosity plastics material.

The rubber mixes also have a very high viscosity, which causes a very great resisting torque on the driving wheel. This resisting torque is all the greater since it is desired to achieve high flow rates by increasing the width of the gear wheels. These difficulties are so great that, in applications of gear pumps to rubber, frequent breakage of the gear wheels is observed.

Furthermore, the achieving of a high flow rate for the rubber mixes is limited by the thermal aspect, because the increase in flow rate, which is mainly a function of the increase in speed of rotation of the gear wheels, is accompanied by a large increase in the temperature of the rubber mixes; now, this temperature must be both controlled and in particular its increase limited in order to avoid early vulcanization of these mixes.

### SUMMARY OF THE INVENTION

The invention aims to overcome all these drawbacks. According to the invention, the volumetric pump in particular for rubber mixes, comprising feeding means for delivering the material to an enclosure which opens into an outlet orifice and in which rotate two contra-rotating screws which mesh with one another by means of the respective helicoidal threads which they bear, the axial length of the meshing zone of these screws being greater than or equal to the total of the helix pitch of the threads and of the helix pitch multiplied by the number of threads of each screw multiplied by 2. The contra-rotating screws mesh without contact.

This embodiment makes it possible to ensure the volumetric flow of the pumping and the reliability of the pump by the transmission of a driving torque to each screw.

### DESCRIPTION OF THE DRAWINGS

Other characteristics and advantages of the invention will become apparent on reading an example of embodiment of a volumetric pump according to the invention, with reference to the drawings, in which:

FIG. 1 is a longitudinal section through the pump according to the invention along the plane passing through the axes of rotation of each of the screws,

FIG. 2 is a radial section through the pump according to the invention along the line II-II shown in FIG. 1.

### DESCRIPTION OF A PREFERRED EMBODIMENT OF THE INVENTION

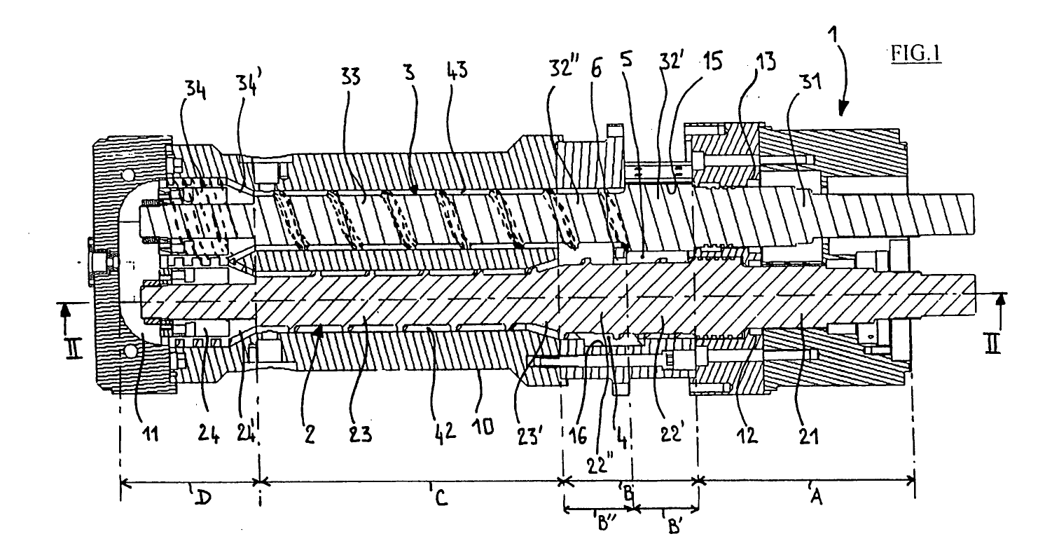

In FIG. 1, the gear pump 1 comprises a body 10 which bears two contra-rotating screws 2 and 3 having axes which are parallel to each other. The free ends 24 and 34 of these two screws 2 and 3 cooperate together by means of their helicoidal threads, within an enclosure 11 borne by the body 10 so as to pump volumetrically. Note that only the screw threads of the screw 3 have been shown in broken lines in FIG. 1.

As will be seen in greater detail hereafter, the ends 24 and 34 form an association of elements comparable to a gear system although there is no contact between the ends 24 and 34, nor between their threads.

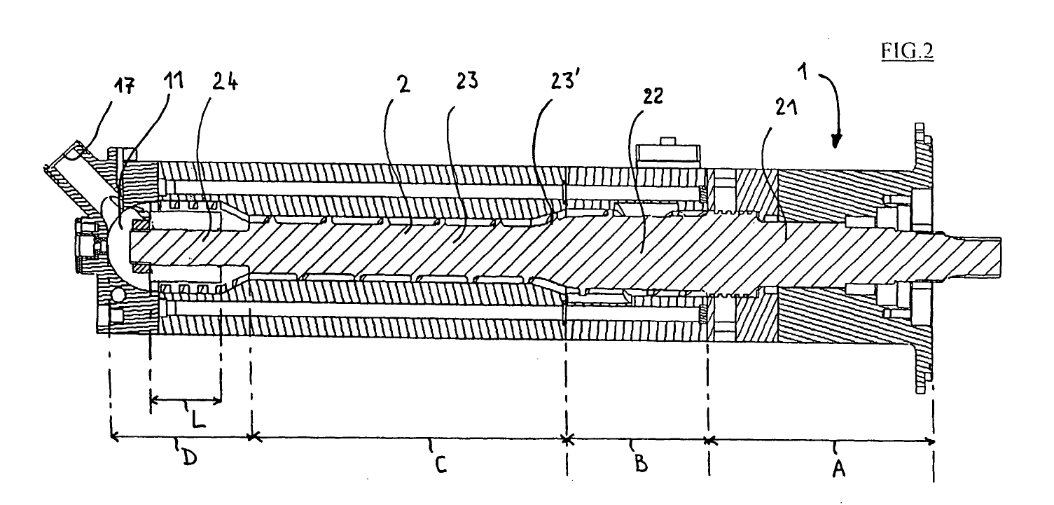

Thus each screw 2, 3 thus comprises a plurality of zones, the function and environment of which are different, which will be referred to as zones A, B, C and D in FIGS. 1 and 2 for greater clarity.

Each screw 2, 3 thus has:

an end 21, 31 each connected to a motorization means permitting rotation of the screw on its axis and hence the operation of the pump, the two ends 21 and 31 being located in distinct housings 12 and 13 borne by the body 10, corresponding to the zone A,

a feed zone B which follows the zone A in the direction of advance of a mix upon rotation of the screws, in which the parts 22,32 of each screw 2,3 rotate in a common chamber 4 without however the screw threads being in contact, one of the screws 2 in this zone having a diameter greater than the other screw,

a zone C for transmitting the flows of material succeeds the zone B where separation of the flows of mixes arriving on the corresponding screw parts 23 and 33 was effected, the chamber 4 having divided into two chambers 42 and 43. In this zone the two screws 2 and 3 are of the same diameter.

Finally, a volumetric pumping zone D in which the two free ends 24 and 34 of the screws 2 and 3 cooperate in the same enclosure, which is the enclosure 11.

The zone A therefore corresponds to the motorization of the pump by the motorization of each of the screws 2 and 3. In this embodiment, a single motor with a specific reducing gear is used to drive each of the screws. This reducing gear imposes an angular clearance between the screws 2 and 3, which prevents their free ends 24 and 34 from mechanical contact.

Furthermore, still in order to avoid any mechanical contact between the ends 24 and 34, bilateral mechanical stops (not shown) in zone A axially position the two screws 2 and 3. These arrangements make the pump more reliable and robust since the free ends of the screws 24 and 34 which form a sort of gear system are motor-driven independently of each other, neither of the two ends entraining the other in its rotation.

The zone B for feeding with mix is itself divided axially into a zone B′ and a zone B″ which are defined by the radial wall 6, the zone B′ being defined by the inner wall 15 of the body 10.

The chamber 4 located in the zone B″ is fed via a single feed orifice 5 arranged in the zone B′ circumferentially in the inter-axial space of the two screws 2 and 3, and therefore at the level of the parts 22′ and 32′ of the two screws.

The zone 32′ of the screw 3 of lesser diameter acts as a feed roller for the other screw, this zone not having any thread and its diameter placing it in contact with the wall 15 of the body 10. The mix is caused to pass from the inter-axial space of the two screws to the chamber 4 by a thread 16 cut into the body 10 which opens into the zone B″.

The difference in diameter in this zone B generally makes it possible to facilitate the supply of mix and thus to effect the feeding of the pump. The passage from the zone B″ to the zone C consists of a division of the chamber 4 into two and into a conical part 23′ of the screw 3 in order to reduce its diameter to a diameter identical to that of the screw 3. The screws 2 and 3 must in fact have the same torsion and the same flow rate upstream of their free ends for the pump to be able to function.

Conversely, in the zone D, each screw has a conical zone respectively 24′ and 34′ which makes it possible to increase their diameter to adjust the flow rate between the zones C and D.

In order to produce a zone D which is volumetric, the helicoidal threads of each screw end 24, 34 must cooperate with the other screw end 34, 24 without contact, but having a very small clearance between them and these screw ends 24 and 34 must be such that their respective axial length L (FIG. 2) is greater than or equal to the total of the helix pitch of the threads and of the helix pitch multiplied by the number of threads of each screw multiplied by 2.

Thus tightness is ensured in the zone of admission into the enclosure 11, by then optimizing the number of helicoidal threads on each end 24, 34 which will correspond at least to one thread groove in admission, one in delivery and one between the two.

Different forms may be selected for the structure of the helicoidal threads. In particular, one advantageous form is to use involutes to circles for the flanks of the threads.

In order to have a sufficient pressure at the pump and to ensure feeding, it is advantageous to provide for oversizing the screws with a flow rate in the feed zone B which is greater than the flow rate in the working zone C, which in turn is greater than that which it is desired to obtain in the zone D.

The enclosure 11 opens on to a system which converges towards an outlet orifice 17, as can be seen in FIG. 2.

Although the present invention has been described in connection with a preferred embodiment thereof, it will be appreciated by those skilled in the art that additions, modifications, substitutions and deletions not specifically described may be made without departing from the spirit and scope of the invention as defined in the appended claims.

What is claimed is:

1. A volumetric pump in particular for rubber mixes, comprising feeding means for delivering the material to an enclosure which opens into an outlet orifice and in which rotate two contra-rotating screws which mesh with one another by means of the respective helicoidal threads which they bear, the axial length of the meshing zone of these screws being greater than or equal to the total of the helix pitch of the threads and of the helix pitch multiplied by the number of threads of each screw multiplied by two.

2. A pump according to claim 1, in which the contra-rotating screws mesh without contact.

3. A pump according to claim 1, in which the two meshing screws are driven directly by an identical driving torque.

4. A pump according to claim 1, in which the feeding means are formed by two feed screws, the free ends of which form the meshing screws.

5. A pump according to claim 4, in which the feed screws comprise a feed zone in which they are mounted in a common feed chamber, a zone for transmitting the flows of material in which the common chamber is divided into two distinct chambers and the volumetric pumping zone in which the distinct chambers rejoin to form the enclosure in which the meshing screws rotate.

6. A pump according to claim 5, in which one of the feed screws acts as a feeding roller for the other screw in the feed zone.

7. A pump according to claim 4 in which the diameter of the feed screws is determined in the different feed, transmission and pumping zones such that the flow rate in the feed zone is greater than the flow rate in the transmission zone, which in turn is greater than the flow rate in the pumping zone.
